(19) United States
(12) Patent Application Publication
(10) Pub. No.: US 2017/0285407 A1
(43) Pub. Date: Oct. 5, 2017

(54) BACKLIGHT MODULE AND DISPLAY DEVICE

(71) Applicants: Le Holdings (Beijing) Co., Ltd., Beijing (CN); LE SHI ZHI XIN ELECTRONIC TECHNOLOGY (TIAN JIN) LIMITED, Tianjin (CN)

(72) Inventors: Kunpeng Zhu, Tianjin (CN); Zhishuai Jia, Tianjin (CN); Xianlei Meng, Tianjin (CN); Jinnan Zhang, Tianjin (CN); Fangdai Ye, Tianjin (CN)

(73) Assignees: Le Holdings (Beijing) Co., Ltd., Beijing (CN); LE SHI ZHI XIN ELECTRONIC TECHNOLOGY (TIAN JIN) LIMITED, Tianjin (CN)

(21) Appl. No.: 15/243,686

(22) Filed: Aug. 22, 2016

Related U.S. Application Data
(63) Continuation of application No. PCT/CN2016/088974, filed on Jul. 6, 2016.

(30) Foreign Application Priority Data
Mar. 30, 2016 (CN) 201610195660.9

(51) Int. Cl. G02F 1/1335

(52) U.S. Cl. CPC G02F 1/133611

(57) ABSTRACT

Disclosed are a backlight module and a display device. The backlight module includes an elastically deformable back cover, a memory structural piece connected with a bottom wall of the back cover, and a printed circuit board, wherein there is an electrically heating wire in the memory structural piece, both ends of the electrically heating wire are electrically connected with the printed circuit board to form a heating loop. With the technical solution according to the embodiment of the disclosure, the thickness of the display device can be decreased to thereby improve a display effect on a curve display surface of the display device, and furthermore displaying can be converted between the curve display surface and a planar display surface to thereby accommodate more application scenarios of the display device.

### CROSS-REFERENCE TO RELATED APPLICATIONS

This application is a continuation of International Application No. PCT/CN2016/088974, filed Jul. 6, 2016, which claims the priority to Chinese Patent Application No. 201610195660.9, filed on Mar. 30, 2016, both of which are hereby incorporated by reference in their entireties.

### FIELD

The present disclosure relates to the field of display technologies, and particularly to a backlight module and a display device.

### BACKGROUND

Among flat panel display devices, a Thin Film Transistor Liquid Crystal Display (TFT-LCD) has become dominating in the current market of flat panel displays due to its small volume, low power consumption, low manufacturing cost, no radiation, and other characteristics.

At present, a display device with a curve display surface has become a new trend of developing display technologies. In the prior art, in order to provide the TFT-LCD with a curve display surface, spacers with different heights are arranged between a backlight module and a display panel, and the distribution of the heights of the spacers is controlled so that the display panel is curved to some extent to thereby provide a curve surface display.

The inventors have identified during making of the disclosure that the drawback of the existing display device with a curve display surface lies in that the spacers are arranged between the backlight module and the display panel so that the thickness of the display device is large, thus influencing a visual effect; and moreover while the existing display device with a curve display surface is displaying, a light source emitted by the backlight module is a planar light source which does not match with the display panel in the curve shape, thus influencing a display effect on the curve display surface.

### SUMMARY

The disclosure provides a backlight module and a display device so as to decrease the thickness of the display device to thereby improve a display effect on a curve display surface of the display device, and moreover so as to convert displaying between the curve display surface and a planar display surface to thereby accommodate more application scenarios of the display device.

Some embodiments of the disclosure provide a backlight module including an elastically deformable back cover, a memory structural piece connected with the bottom wall of the back cover, and a printed circuit board, wherein there is an electrically heating wire in the memory structural piece, both ends of the electrically heating wire are electrically connected with the printed circuit board to form a heating loop.

Optionally the memory structural piece is clad with a thermally insulating layer.

Optionally when the heating loop is opened, the memory structural piece is plane-shaped.

Optionally when the heating loop is closed, the memory structural piece is arced backward in the lengthwise direction of the back cover.

Optionally the memory structural piece is connected with the bottom inner wall of the back cover.

Optionally the memory structural piece is connected with the bottom outer wall of the back cover.

Optionally there are at least two memory structural pieces, each of which is shaped like a strip, and arranged in the lengthwise direction of the back cover.

Optionally the memory structural piece is a planar memory structural piece matching with the shape of the bottom wall of the back cover.

Optionally the memory structural piece is riveted, bonded, or bolted with the bottom wall of the back cover.

In the technical solutions according to the embodiments of the disclosure, the memory structural piece is heated by the heating loop due to a shape memory effect of the memory structural piece, and if the memory structural piece is heated to memory temperature thereof, then the memory structural piece will be curved to thereby bring the backlight module and a display panel into curving, thus providing a curve surface display of a display device; and if the heating loop is opened, then the memory structural piece will bring the backlight module and the display panel into being planar, thus providing a planar surface display of the display device. As compared with the prior art, no spacers will be arranged between the backlight module and the display panel to thereby decrease the thickness of the display device to thereby improve a display effect on the curve display surface of the display device, and moreover so as to convert displaying between the curve display surface and the planar display surface to thereby accommodate more application scenarios of the display device.

Some embodiments of the disclosure provide a display device including the backlight module according to any one of the technical solutions above, and a display panel. The thickness of the display device can be made smaller, and a display effect on the curve display surface can also be improved; and furthermore displaying can be converted between the curve display surface and the planar display surface to thereby accommodate more application scenarios of the display device.

### BRIEF DESCRIPTION OF THE DRAWINGS

In order to make the technical solutions according to the embodiments of the disclosure or in the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a schematic diagram of a memory structural piece and a back cover, both of which are curved, according to some embodiments of the disclosure;

FIG. 2 is a schematic diagram a memory structural piece and a back cover, both of which are planar, according to some embodiments of the disclosure; and

FIG. 3 is a schematic diagram of a memory structural piece and a back cover, both of which are curved, according to another embodiment of the disclosure.

### REFERENCE NUMERALS

10—Back cover; 20—Memory structural piece; 21—Electrically heating wire; 22—Connection hole

### DETAILED DESCRIPTION OF THE EMBODIMENTS

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

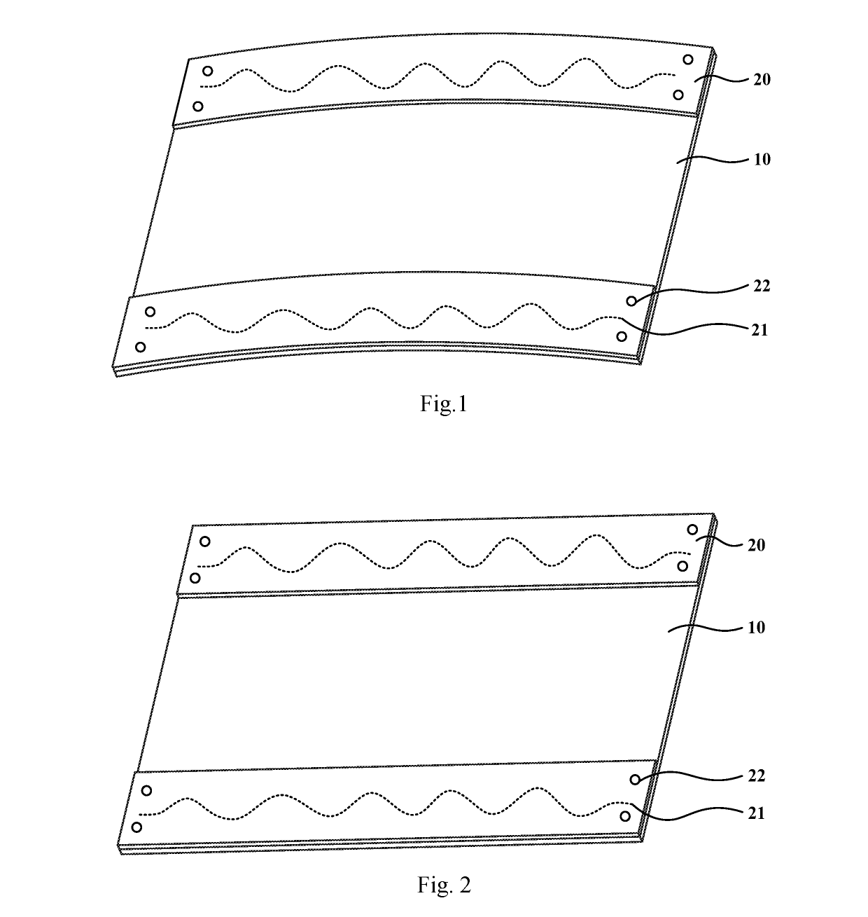

As illustrated in FIG. 1, a backlight module according to some embodiments of the disclosure includes an elastically deformable back cover 10, a memory structural piece 20 connected with the bottom wall of the back cover, and a printed circuit board (not illustrated), where there is an electrically heating wire 21 in the memory structural piece 20, both ends of the electrically heating wire are electrically connected with the printed circuit board to form a heating loop.

In the technical solution according to the embodiment of the disclosure, the memory structural piece 20 is heated by the heating loop due to a shape memory effect of the memory structural piece 20, and when the memory structural piece 20 is heated to memory temperature thereof, the memory structural piece 20 is curved to thereby bring the backlight module and a display panel into curving, thus providing a curve surface display of a display device; and when the heating loop is opened, the memory structural piece brings the backlight module and the display panel into being planar, thus providing a planar surface display of the display device. As compared with the prior art, no spacers will be arranged between the backlight module and the display panel to thereby decrease the thickness of the display device to thereby improve a display effect on the curve display surface of the display device, and moreover so as to convert displaying between the curve display surface and the planar display surface to thereby accommodate more application scenarios of the display device.

Particularly the elastically deformable back cover 10 will not be limited to any particular material, for example, it can be made of spring steel, beryllium bronze, or another high elasticity metal material.

The shape memory effect of the memory structural piece particularly refers to that the general material of the memory structural piece is a shape memory alloy which is structured in a first shape above memory temperature, and in a second shape below the memory temperature. The memory structural piece is heated by the heating loop, and when the temperature rises above the memory temperature, the structure of crystals in the shape memory alloy varies so that the shape memory alloy is deformed, where the shape memory alloy is structured in the first shape; and when the heating loop is opened so that the temperature drops below the memory temperature, the crystals in the shape memory alloy is restored to the original structure, where the shape memory alloy is structured in the second shape.

In a preferred embodiment of the disclosure, the memory structural piece is clad with a thermally insulating layer to thereby alleviate damage for the backlight module from the rising temperature of the memory structural piece.

As illustrated in FIG. 2, in a preferred embodiment of the disclosure, when the heating loop is opened, the memory structural piece 200 becomes planar; and as illustrated in FIG. 1, when the heating loop is closed, the memory structural piece 20 is arched backward in the lengthwise direction of the back cover 20. With this technical solution, the heating loop is controlled to be closed and opened so that the memory structural piece 20 can be structured in the planar and curve shapes to thereby bring the backlight module and the display panel into the planar or curve shape so as to convert displaying on the display device between the planar and curve display surfaces, thus accommodating more application scenarios of the display device.

Moreover it shall be noted that the memory structural piece is arched backward into such a curve surface in the lengthwise direction of the back cover that will not be limited to any particular curvature, but the curvature of the curve surface can be determined as a function of the particular type, application scenario, etc., of the display device.

In some embodiments of the disclosure, the memory structural piece is connected with the bottom inner wall of the back cover; or the memory structural piece is connected with the bottom outer wall of the back cover.

The memory structural piece in the embodiment of the disclosure will not be limited to any particular shape. As illustrated in FIG. 1, for example, there are at least two memory structural pieces, each of which is shaped like a strip, and arranged in the lengthwise direction of the back cover so that the memory structural pieces can apply more balanced acting forces to the backlight module and the display panel to thereby bring the backlight module and the display panel into curving so as to further improve a display effect on the curve surface of the display device.

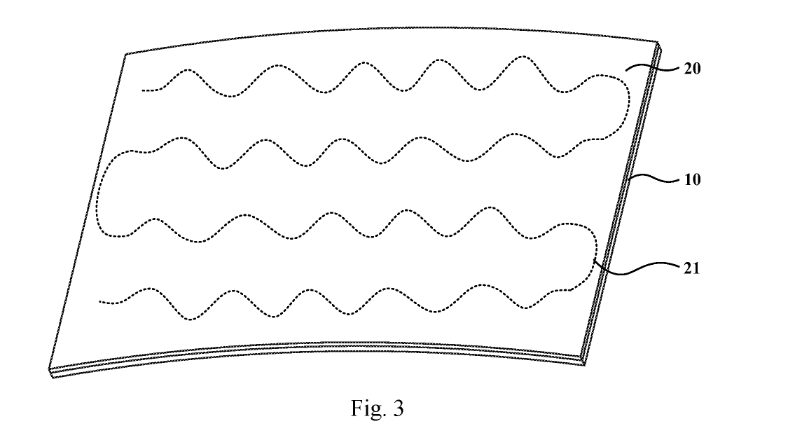

As illustrated in FIG. 3, the memory structural piece 20 can alternatively be a planar memory structural piece matching with the shape of the bottom wall of the back cover 10. With this technical solution, the memory structural piece can also apply more balanced acting forces to the backlight module and the display panel to thereby bring the backlight module and the display panel into curving so as to further improve a display effect on the curve surface of the display device.

As illustrated in FIG. 1, the memory structural piece 20 can be connected with the back cover 10 particularly in any appropriate manner, for example, they can be riveted, bonded, or bolted with each other; and if they are riveted or bolted, then several connection holes 22 will be opened respectively at several positions on the memory structural piece 20 corresponding to the back cover 10.

In summary, as compared with the prior art, with the backlight module according to the embodiment of the disclosure, the thickness of the display device can be decreased to thereby improve a display effect on the curve display surface of the display device, and furthermore displaying can be converted between the curve display surface and a planar display surface to thereby accommodate more application scenarios of the display device.

Some embodiments of the disclosure further provide a display device including the backlight module according to any one of the technical solutions above and a display panel. As compared with the prior art, with the backlight module according to the embodiment of the disclosure, the thickness of the display device can be decreased to thereby improve a display effect on the curve display surface of the display device, and furthermore displaying can be converted between the curve display surface and a planar display surface to thereby accommodate more application scenarios of the display device. The display device will not be limited to any particular type, for example, the display device can be a liquid crystal TV set, a liquid crystal display screen, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A backlight module, comprising an elastically deformable back cover, a memory structural piece connected with a bottom wall of the back cover, and a printed circuit board, wherein there is an electrically heating wire in the memory structural piece, both ends of the electrically heating wire are electrically connected with the printed circuit board to form a heating loop.

2. The backlight module according to claim 1, wherein the memory structural piece is clad with a thermally insulating layer.

3. The backlight module according to claim 1, wherein when the heating loop is opened, the memory structural piece is plane-shaped.

4. The backlight module according to claim 1, wherein when the heating loop is closed, the memory structural piece is arced backward in a lengthwise direction of the back cover.

5. The backlight module according to claim 1, wherein the memory structural piece is connected with a bottom inner wall of the back cover.

6. The backlight module according to claim 1, wherein the memory structural piece is connected with a bottom outer wall of the back cover.

7. The backlight module according to claim 1, wherein there are at least two memory structural pieces, each of which is shaped like a strip, and arranged in a lengthwise direction of the back cover.

8. The backlight module according to claim 1, wherein the memory structural piece is a planar memory structural piece matching with the shape of the bottom wall of the back cover.

9. The backlight module according to claim 1, wherein the memory structural piece is riveted, bonded, or bolted with the bottom wall of the back cover.

10. A display device, comprising a backlight module and a display panel,
wherein the backlight module comprises an elastically deformable back cover, a memory structural piece connected with a bottom wall of the back cover, and a printed circuit board; wherein there is an electrically heating wire in the memory structural piece, both ends of the electrically heating wire are electrically connected with the printed circuit board to form a heating loop.

11. The display device according to claim 10, wherein the memory structural piece is clad with a thermally insulating layer.

12. The display device according to claim 10, wherein when the heating loop is opened, the memory structural piece is plane-shaped.

13. The display device according to claim 10, wherein when the heating loop is closed, the memory structural piece is arced backward in a lengthwise direction of the back cover.

14. The display device according to claim 10, wherein the memory structural piece is connected with a bottom inner wall of the back cover.

15. The display device according to claim 10, wherein the memory structural piece is connected with a bottom outer wall of the back cover.

16. The display device e according to claim 10, wherein there are at least two memory structural pieces, each of which is shaped like a strip, and arranged in a lengthwise direction of the back cover.

17. The display device according to claim 10, wherein the memory structural piece is a planar memory structural piece matching with the shape of the bottom wall of the back cover.

18. The display device according to claim 10, wherein the memory structural piece is riveted, bonded, or bolted with the bottom wall of the back cover.
